(19) United States
(12) Patent Application Publication
(10) Pub. No.: US 2009/0210896 A1
(43) Pub. Date: Aug. 20, 2009

(54) APPARATUS AND METHOD FOR TRANSMITTING/RECEIVING NOTIFICATION MESSAGE IN A DIGITAL VIDEO BROADCASTING SYSTEM

(75) Inventors: Jae-Yeon SONG, Seoul (KR); Ram SUBRAMANIAM, Staines (UK); Kook-Heui LEE, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/372,100

(22) Filed: Feb. 17, 2009

(30) Foreign Application Priority Data
Feb. 15, 2008 (KR) 10-2008-0014151
Feb. 28, 2008 (KR) 10-2008-0018345

(51) Int. Cl. H04N 7/025

(52) U.S. Cl. 725/32

(57) ABSTRACT

An apparatus and method for transmitting/receiving a notification message in a Digital Video Broadcasting (DVB) system are provided, in which a terminal detects an Access Point (AP) from an Electronic Service Guide (ESG) bootstrapping session, queries the AP to request a notification message list or all or part of a notification message over a communication channel, and receives the notification message list or all or part of the notification message from the AP.

### PRIORITY

This application claims the benefit under 35 U.S.C. §119(a) of a Korean patent application filed in the Korean Intellectual Property Office on Feb. 15, 2008 and assigned Serial No. 10-2008-0014151 and a Korean patent application filed in the Korean Intellectual Property Office on Feb. 28, 2008 and assigned Serial No. 10-2008-0018345, the entire disclosures of each of which are hereby incorporated by reference.

### BACKGROUND OF THE INVENTION

1. Field of the Invention

The present invention relates to an apparatus and method for transmitting/receiving a notification message in a Digital Video Broadcasting (DVB) system. More particularly, the present invention relates to an apparatus and method for transmitting/receiving a notification message over a communication channel in a DVB system.

2. Description of the Related Art

Digital Video Broadcasting (DVB) is a European digital broadcasting technology and supports a transmission standard for providing a digital multimedia service through a mobile or portable device as well as a legacy digital broadcasting service.

A DVB system can multiplex Moving Picture Experts Group-2 (MPEG2) Transport Stream (TS)-based broadcasting data and transmit Internet Protocol (IP)-based data streams simultaneously. The DVB system can also transmit multiplexed data from a plurality of services in one IP stream. Therefore, a terminal that supports the DVB system receives the IP stream, demultiplexes the IP stream into the data of the individual services, demodulates the service data, and visually outputs the demodulated service data to a user.

Various services may exist for DVB. One of the services is a transmission of notification messages. The notification messages may include an emergency message, a new service notification message, a stock ticker message, a weather message, and the like.

The notification messages also include a default notification message that all terminals commonly receive without registering to a network, an Electronic Service Guide (ESG) provider, or a platform provider.

The notification messages also include a Service-Related Notification (SRN) message that a terminal can receive after subscription and purchase procedures. As in other general services, information about the SRN is carried in an ESG. That is, if the SRN exists in an ESG, a service connected to the SRN, information about the contents of the service, and session information required for receiving the SRN are included in the ESG.

Therefore, a terminal user can find an intended notification message in a received ESG. Like other services, the user can purchase the notification message in a purchase procedure.

A notification message can take the form of a stand-alone notification service. That is, the notification message itself is defined as a service, rather than a notification message connected to any other general service. In this case, each notification message is identified by a Service IDentifier (ServiceID), not a Message ID (MessageID).

At present, only subscription to and reception of a notification message over a broadcasting channel are defined and transmission of a notification message over a broadcasting channel is yet to be specified.

An exemplary notification message is a notification message for a “notification of the start time of a subscribed service.” The exemplary notification message makes sure that a service purchaser receives a broadcasting service by alerting the service purchaser to the start time of the broadcasting service in advance.

However, in the case where the terminal of the service purchaser is not connected to the broadcasting service when the notification message is transmitted over a broadcasting channel, the terminal cannot receive the notification message. Therefore, to receive every unexpected notification message, the terminal should be kept connected to the broadcasting service all the time, despite this being inefficient.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for transmitting/receiving a notification message in a Digital Video Broadcasting (DVB) system.

In accordance with an aspect of the present invention, an apparatus and method for generating signaling information for delivering a notification message and transmitting/receiving the signaling information over a communication channel in a DVB system are provided.

In accordance with another aspect of the present invention, an apparatus and method for transmitting/receiving a notification message over an interactive network as well as a notification message over a broadcasting channel in a DVB system are provided.

In accordance with yet another aspect of the present invention, an apparatus and method for effectively transmitting/receiving a notification message over an interactive network in a DVB system are provided.

In accordance with still another aspect of the present invention, a method for receiving a notification message at a terminal in a DVB system is provided. The method includes detecting an Access Point (AP) from an Electronic Service Guide (ESG) bootstrapping session, querying the AP to request a notification message list or all or part of a notification message over a communication channel, and receiving the notification message list or all or part of the notification message from the AP.

In accordance with still another aspect of the present invention, a method for transmitting a notification message at a server in a DVB system is provided. The method includes transmitting an ESG bootstrapping session including information about an AP to a terminal, receiving a query about requesting a notification message list or all or part of a notification message from the terminal over a communication channel, and transmitting the notification message list or all or part of the notification message to the terminal.

In accordance with a further aspect of the present invention, a system for transmitting and receiving a notification message in a DVB system is provided. The system includes a server for transmitting an ESG bootstrapping session including information about an AP to a terminal, and for receiving a query about requesting a notification message list or all or part of a notification message from the terminal, and the terminal for receiving the queried notification message list or all or part of the queried notification message from the AP, and a network for transmitting and receiving the query and the queried notification message list or all or part of the queried notification message over one of a communication channel and a broadcasting channel.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a flowchart illustrating a control operation for receiving a notification message at a terminal in a Digital Video Broadcasting (DVB) system according to an exemplary embodiment of the present invention;

FIG. 2 is a flowchart illustrating a control operation for transmitting a notification message at a transmitter in a DVB system according to an exemplary embodiment of the present invention; and

FIG. 3 is a block diagram of a DVB system according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While exemplary embodiments of the present invention are described in the context of an asynchronous mobile communication standard, such as a 3^{rd} Generation Partnership Project (3GPP)-based system or a Digital Video Broadcasting (DVB) system, any reference thereto is merely provided to assist in understanding the exemplary embodiments of the present invention. Accordingly, it is to be appreciated that the standards, systems and their names do not limit the scope of the present invention and that the present invention is applicable to any other standard or system with a similar technological background.

Exemplary embodiments of the present invention provide a method and procedure for transmitting a notification message over a communication channel such as in an interactive network as well as over a broadcasting channel in a DVB system. Exemplary embodiments of the present invention also provide a method and procedure for receiving a notification message over a broadcasting channel or an interactive channel at a terminal.

The DVB system uses at least one of service discovery of a broadcasting reception-enabled terminal, subscription of the terminal to a service, provisioning of control information required for receiving the service, service transmission, and service reception at the terminal.

For service reception, the terminal receives notification messages carrying information about a broadcasting service. The notification messages are a default notification message and a Service-Related Notification (SRN) for a particular service.

Meanwhile, the terminal receives an Electronic Service Guide (ESG) to start the service reception. Some information may change at any time in the ESG and each time a change occurs to the ESG, the ESG should be transmitted to the terminal. Considering the emergence of new terminals inherent to the nature of broadcasting services, the ESG is repeatedly transmitted even though there is no change in the ESG.

Regarding the default notification message, therefore, exemplary embodiments of the present invention indicate an Access Point (AP) from which the terminal can receive the default notification message over a communication channel. The default notification message, which all terminals may receive commonly without any particular subscription to their networks or providers, may be a Network Default Notification (NDN), an ESG Default Notification (EDN), or a Platform Default Notification (PDN).

In accordance with exemplary embodiments of the present invention, information about an AP is added to an ESG bootstrapping session in the DVB system. The AP information addition is exemplified in first and second exemplary embodiments of the present invention, as defined in Table 1 to Table 6.

Meanwhile, after the terminal subscribes to and purchases a particular service, it receives an SRN in an ESG data model. Since the ESG data model is transmitted via an interactive AP, the AP for transmitting the SRN over an interactive network can be determined. Accordingly, exemplary embodiments of the present invention do not provide a scheme for adding AP information in the case of an SRN.

In exemplary embodiments of the present invention, after the terminal acquires information about an AP from the default notification message or the SRN of the interactive network, the terminal can operate as follows.

The terminal requests a notification message list (DeliveryList) of exemplary embodiments of the present invention, or requests transmission of the default notification message over an interactive channel, or requests part of a notification message, via an AP.

Because the terminal receives only information about an AP that transmits the default notification message over a broadcasting channel, it cannot be sure whether it receives the default notification message successfully. Hence, the terminal requests the DeliveryList and acquires a list of default notification messages that a server has transmitted or will transmit to the terminal for a predefined time period, so that it can re-request a failed or erroneous notification message over the communication channel, i.e. over the interactive network.

The DeliveryList can be extended for an SRN. Although the terminal can determine an SRN to be received based on notification message AP information set in an ESG, it may not know the transmission time of the SRN in advance in view of the nature of the SRN. In this case, the terminal requests a DeliveryList for SRNs and checks the SRN in the DeliveryList, to thereby make sure that it has received the SRN accurately or re-requests an erroneous SRN.

In this context, exemplary embodiments of the present invention define a novel Hyper Text Transfer Protocol (HTTP) query format for requesting the information, shown in Tables 7A, 7B and 7C.

After transmitting a query to the server, the terminal receives all or part of a requested notification message, or a DeliveryList from the server. Table 8A to Table 9 show Extensible Markup Language (XML) syntaxes and semantics of the proposed DeliveryList.

### <<Define AP>>

An exemplary embodiment of the present invention will be described, in which AP information is added to an ESG bootstrapping session.

Table 1 and Table 4 list XML syntaxes and semantics of descriptors for indicating an AP from which the default notification message can be received in the ESG bootstrapping session. The AP is indicated by PDNIAEntry( ) and EDNIA Entry( ) that are added by exemplary embodiments of the present invention.

Syntaxes of PDNIAEntry( ) and EDNIA Entry( ) are shown in Tables 2A, 2B and 2C, and in Tables 3A, 3B and 3C, respectively, and semantics of PDNIAEntry( ) and EDNIA Entry( ) are shown in Table 5.

Table 2A and Table 2B define two examples of the syntax of PDNIAEntry( ). They differ in whether they add an “IAmode” value indicating an interactive transmission mode or not.

Table 3A and Table 3B define two examples of EDNIAEntry( ) according to whether they have the additional “IAmode” value.

In Table 1, the information of PDNEntry( ) and EDNEntry( ) provides an IP address of an AP of a server that broadcasts a default notification message. On the other hand, in Tables 2A to 3B, the information of PDNEntry( ) and EDNEntry( ) provides a Universal Resource Indicator (URI) of an AP of an interactive server.

Two modes are available for interactive transmission, “PUSH” and “PULL”. In the PUSH mode, a server transmits information to a particular terminal, whereas in the PULL mode, the terminal makes a request for information to the server and receives the information from the server. The AP of the interactive server according to exemplary embodiments of the present invention can perform the two modes according to characteristics of the server.

To indicate a supported mode to the terminal, the server transmits ‘IAmode’ information to the terminal. If ‘IAmode’ is “PUSH”, the terminal may be aware of the address of the AP from the PUSH server and thus may consider a pushed signal from the server reliable. If ‘IAmode’ is “PULL”, the terminal may be aware of the AP by the URL of the server that it can query. When needed, the terminal queries the AP (refer to Table 5).

Compared to the above-described exemplary embodiments of the present invention, ‘Purchase_item_ID’ information is transmitted in Tables 2C and 3C, so that a service provider can charge for the default notification message when it is transmitted to the interactive network.

Aside from the default notification message transmitted over a broadcasting network without subscription, a notification message transmitted over an interactive network may require subscription and purchase procedures. The purchase procedure is performed by identifying ‘Purchase_item_ID’ for each purchase item. Therefore, ‘Purchase_item_ID’ is allocated to each default notification message entry to make the function viable. ‘Purchase_item_ID’ can be specific to every default notification message.

The above-described exemplary embodiments of the present invention are embodied in the context of major information. Syntaxes described in the exemplary embodiments can be used in combination. That is, apart from the basic default message entry information, ‘IAmode’ and ‘Purchase_item_ID’ can be used together.

TABLE 1
DefaultNotificationAccessDescriptorSyntax

| Syntax | No. of bits | Mnemonic |
|---|---|---|
| DefaultNotificationAccessDescriptor { | | |
| PDNFlag | 1 | uimsbf |
| Reserved | 7 | uimsbf |
| n_o_EDNEntries | 8 | uimsbf |
| If(PDNFlag){ | | |
| PDNEntry( ) | | |
| PDNIAEntry( ) | | |
| } | | |
| For(i=0;i< n_o_{—} EDNEntries;i++){ | | |
| EDNEntry[i]( ) | | |
| EDNIAEntry[i]( ) | | |
| } | | |
| } | | |
| PDNEntry{ | | |
| PDNEntryversion | 8 | uimsbf |
| EntryLength | 8+ | vluimsbf8 |
| IPVersion6 | 1 | bslbf |
| Reserved | 7 | bslbf |
| If(IPVersion6){ | | |
| SourceIPAddress | 128 | bslbf |
| DestinationIPAddress | 128 | bslbf |
| }else{ | | |
| SourceIPAddress | 32 | bslbf |
| DestinationIPAddress | 32 | bslbf |
| } | | |
| Port | 16 | uimsbf |
| TSI | 16 | uimsbf |
| } | | |
| } | | |
| EDNEntry{ | | |
| EDNEntryVersion | 8 | uimsbf |
| EntryLength | 8+ | vluimsbf8 |
| ProviderID | 16 | uimsbf |
| IPVersion6 | 1 | bslbf |
| Reserved | 7 | bslbf |
| If(IPVersion6){ | | |
| SourceIPAddress | 128 | bslbf |
| DestinationIPAddress | 128 | bslbf |
| }else{ | | |
| SourceIPAddress | 32 | bslbf |
| DestinationIPAddress | 32 | bslbf |
| } | | |
| Port | 16 | uimsbf |
| TSI | 16 | uimsbf |
| } | | |
| } | | |

TABLE 2A
PDNIAEntry Syntax

| Syntax | No. of bits | Mnemonic |
|---|---|---|
| PDNIAEntry{ | | |
| PDNIAEntryversion | 8 | uimsbf |
| EntryLength | 8+ | vluimsbf8 |
| Reserved | 8 | bslbf |
| For(i=0; i<URILength ; i++){ | | |
| URIByte | | |
| } | | |
| } | | |

TABLE 2B
PDNIAEntry Syntax

| Syntax | No. of bits | Mnemonic |
|---|---|---|
| PDNIAEntry{ | | |
| Iamode | 1 | bslbf |
| Reserved | 7 | bslbf |
| PDNIAEntryversion | 8 | uimsbf |
| EntryLength | 8+ | vluimsbf8 |
| Reserved | 8 | bslbf |
| For(i=0; i<URILength ; i++){ | | |
| URIByte | | |
| } | | |
| } | | |

TABLE 2C
PDNIAEntry Syntax

| Syntax | No. of bits | Mnemonic |
|---|---|---|
| PDNIAEntry{ | | |
| Purchase_item_ID | 8 | uimsbf |
| PDNIAEntryversion | 8 | uimsbf |
| EntryLength | 8+ | vluimsbf8 |
| Reserved | 8 | bslbf |
| For(i=0; i<URILength ; i++){ | | |
| URIByte | | |
| } | | |
| } | | |

TABLE 3A
EDNIAEntry Syntax

| Syntax | No. of bits | Mnemonic |
|---|---|---|
| EDNIAEntry{ | | |
| EDNIAEntryversion | 8 | uimsbf |
| EntryLength | 8+ | vluimsbf8 |
| ProviderID | 16 | vluimsbf8 |
| Reserved | 8 | bslbf |
| For(i=0; i<URILength ; i++){ | | |
| URIByte | | |
| } | | |
| } | | |

TABLE 3B
EDNIAEntry Syntax

| Syntax | No. of bits | Mnemonic |
|---|---|---|
| EDNIAEntry{ | | |
| Iamode | 1 | bslbf |
| Reserved | 7 | bslbf |
| EDNIAEntryversion | 8 | uimsbf |
| EntryLength | 8+ | vluimsbf8 |
| ProviderID | 16 | vluimsbf8 |
| Reserved | 8 | bslbf |
| For(i=0; i<URILength ; i++){ | | |
| URIByte | | |
| } | | |
| } | | |

TABLE 3C
EDNIAEntry Syntax

| Syntax | No. of bits | Mnemonic |
|---|---|---|
| EDNIAEntry{ | | |
| Purchase_item_ID | 8 | uimsbf |
| EDNIAEntryversion | 8 | uimsbf |
| EntryLength | 8+ | vluimsbf8 |
| ProviderID | 16 | vluimsbf8 |
| Reserved | 8 | bslbf |
| For(i=0; i<URILength ; i++){ | | |
| URIByte | | |
| } | | |
| } | | |

TABLE 4
DefaultNotificationAccessDescriptor Semantics

| Field | Semantics |
|---|---|
| PDNFlag | Indicates whether there is a PDN entry in a current descriptor. If |
| | set to “1”, there is a PDN entry following a “n_o_EDNEntries” |
| | field. |
| n_o_EDNEntries | Specifies the number of EDN Entries in which access |
| | information of an EDN service is signaled. |
| n_o_IAEDNEntries | Specifies the number of EDN Entries in which access |
| | information of an EDN service is signaled in an interactive |
| | channel. |
| PDNEntryVersion | Specifies the version of a PDN Entry Specification. The value |
| | shall be set to “1”. |
| | NOTE 1: This version is incremented if the specification of the |
| | PDN Entry is changed in a way that is not forward compatible; |
| | NOTE 2: A receiver should only decode the PDN Entries which |
| | it complies to. |
| EDNEntry Version | Specifies the version of an EDN Entry Specification. The value |
| | shall be set to “1”. |
| | NOTE 3: This version is incremented if the specification of the |
| | EDN Entry is changed in a way that is not forward compatible; |
| | NOTE 4: A receiver should only decode the EDN Entries which |
| | it complies to. |
| EntryLength | Specifies the length of the PDN/EDN Entry in Bytes excluding |
| | the PDNEntryVersion/EDNEntryVersion and EntryLength |
| | fields. |
| | NOTE 5: This allows forward compatible implementations even |
| | if fields are added in the future to a |
| | DefaultNotificationAccessDescriptor. |
| IPVersion6 | If set to “1” this specifies that the SourceIPAddress and the |
| | DestinationIPAddress are signaled according to IP version 6. If |
| | set to “0” this specifies that the SourceIPAddress and the |
| | DestinationIPAddress are signaled according to IP version 4. |
| ProviderID | This ID is used to uniquely identify the ESG provider in the |
| | ESGProviderDiscoveryDescriptor. The ESG provider must |
| | register the ProviderID at the authority that manages the |
| | bootstrapping channel to guarantee uniqueness. |
| SourceIPAddress | Specifies the source IP address of the FLUTE session |
| | transporting the PDN/EDN messages. The IP Version is |
| | signaled by the IPVersion6 field. |
| DestinationIPAddress | Specifies the destination IP address of the FLUTE session |
| | transporting the PDN/EDN messages. The IP Version is |
| | signaled by the IPVersion6 field. |
| Port | Specifies the port number of the IP Stream of the FLUTE |
| | session in which the PDN/EDN messages is transported. |
| TSI | Specifies the Transport Session Identifier (TSI) of the FLUTE |
| | session in which the PDN/EDN messages is transported. |

TABLE 5
Semantics of Table 2A to Table 3C

| Field | Semantics |
|---|---|
| IAmode | If the IA delivery mode is PULL, the value shall be set to “1”. In |
| | a case of PUSH, the value shall be set to “0”. |
| PDNIAEntryVersion | Specifies the version of a PDNIA Entry Specification. The value |
| | shall be set to “1”. |
| | NOTE 1: This version is incremented if the specification of the |
| | PDNIA Entry is changed in way that is not forward compatible; |
| | NOTE 2: A receiver should only decode the PDNIA Entries |
| | which it complies to. |
| EDNIAEntryVersion | Specifies the version of an EDNIA Entry Specification. The |
| | value shall be set to “1”. |
| | NOTE 3: This version is incremented if the specification of the |
| | EDNIA Entry is changed in a way that is not forward |
| | compatible; |
| | NOTE 4: A receiver should only decode EDNIA Entries which it |
| | complies to. |
| EntryLength | Specifies the length of the PDNIA/EDNIA Entry in Bytes |
| | excluding the PDNIAEntryVersion/EDNIAEntryVersion and |
| | EntryLength fields. |
| ProviderID | This ID is used to uniquely identify the ESG provider in the |
| | ESGProviderDiscoveryDescriptor. The ESG provider registers |
| | the ProviderID at the authority that manages the bootstrapping |
| | channel to guarantee uniqueness. |
| URIByte | URIBytes forming the UTF-8 encoded interactive Default |
| | Interactive Notification AccessPoint URL. |
| Purchase_item_ID | Identify the PDNIAEntry or EDNIAEntry. This information is |
| | used as the identifier for the purchase of interactive default |
| | notification. |

### Embodiment 2

Table 6 shows another exemplary embodiment of the present invention that adds AP information to an ESG bootstrapping session.

In the first and second exemplary embodiments of the present invention, information is defined alike. To be more specific, PDNIAEntry( ) and EDNIAEntry[i]( ) are defined in DefaultNotificationAccessDescriptors in the first exemplary embodiment of the present invention, while DefaultNotificationIAAccessDescriptors are defined in the second exemplary embodiment of the present invention.

TABLE 6
DefaultNotificationIAIAAccessDescriptor Syntax

| Syntax | No. of bits | Mnemonic |
|---|---|---|
| DefaultNotificaionIAAccessDescriptor { | | |
| PDNFlag | 1 | uimsbf |
| Reserved | 7 | uimsbf |
| n_o_IAEDNEntries | 8 | uimsbf |
| If(PDNFlag){ | | |
| PDNIAEntry( ) | | |
| } | | |
| For(i=0;i< n_o_IAEDNEntries;i++){ | | |
| EDNIAEntry[i]( ) | | |
| } | | |
| } | | |

### <<Define HTTP Query Format>>

Tables 7A, 7B and 7C are query formats for a notification message, proposed in exemplary embodiments of the present invention according to their applications. On the assumption that HTTP/1.1 POST is used as a protocol, exemplary embodiments of the present invention define ‘Key’ values, values of ‘Value’ of ‘Key’ values, and their semantics. A plurality of key values can be used simultaneously and can be selectively used according to a terminal's request.

As shown in Tables 7A, 7B and 7C, if the terminal requests “type=NotificationDeliveryList”, it can request a DeliveryList of notification messages transmitted for a predefined time period by setting a notification message type “NotiType=EDN” or setting “StartDelivery” and “StopDelivery”.

If the terminal requests “type=NotificationMessage”, it can request transmission of a notification message or retransmission of an erroneous part of an already received notification message by setting MessageID or indicating part of a notification message with MessageID using Content-ID and Content-Position.

If the terminal requests “type=NotificationInitContainer”, the server can transmit an address at which the terminal can receive an InitContainer or it can transmit an InitContainer directly to the terminal.

If “type=DefaultNotification”, this is a query format by which the terminal requests that all default notification messages transmitted over a broadcasting network should be transmitted over an interactive network.

TABLE 7A
IA Notification query format

| Key | Value | Semantics |
|---|---|---|
| Type | Notification DeliveryList | The Type of expected response, |
| | Notification Messages | e.g. if a Notification Delivery |
| | Notification Init Container | List or Containers are |
| | Default Notification | requested. |
| NotiType | NDN | Type of notification messages |
| | (Network Default Notification) | or delivery list is requested. |
| | PDN | Multiple values are possible |
| | (Platform Default Notification) | separated by comma. |
| | EDN | ‘All DN’ means all Default |
| | (ESG provider Default | notification types. |
| | Notification) | |
| | All DN | |
| MessageID | 16 bit positive integer | The requested Notification |
| | | message ID. |
| MessageVersion | Unsigned byte | Version number of the |
| | | notification message. |
| Content-ID | anyURI | ID of the notification message |
| | | part. |
| Content-Position | 16 bit positive integer | Index of multipart/related |
| | | message part that contains the |
| | | corresponding notification |
| | | message part. |
| Content-Type | String | Indicates the Multipurpose |
| | | Internet Mail Extensions |
| | | (MIME) type of the |
| | | corresponding notification |
| | | message part. |
| Content-Transfer- | String | Indicates the type of content |
| Encoding | | transfer encoding applied to the |
| | | corresponding notification |
| | | message part. |
| Subscription | String | Subscription related |
| information | | information e.g. price, currency |
| | | type, purchase type, etc. |
| StartDelivery | Date &Time (Network Time | Start time of the period of |
| | Protocol (NTP) timestamp, | interest, this time is based |
| | unsignedInt) | on the Notification message |
| | | delivery time, either for the |
| | | messages or for the delivery |
| | | list. |
| StopDelivery | Date &Time (NTP timestamp, | Stop time of the period of |
| | unsignedInt) | interest, this time is based |
| | | on the Notification message |
| | | delivery time, either for the |
| | | messages or for the delivery |
| | | list. |
| ValidFrom | Date &Time (NTP timestamp, | Start time of the period of |
| | unsignedInt) | interest, this time is based on |
| | | the Notification message |
| | | expiration time. |
| ValidTo | Date &Time (NTP timestamp, | Stop time of the period of |
| | unsignedInt) | interest, this time is based on |
| | | the Notification message |
| | | expiration time. |
| DeliveryListVersion | LASTUPDATED dateTime | LASTUPDATED version of a |
| | value (NTP timestamp, | DeliveryList. |
| | unsignedInt) | |

Table 7B shows an exemplary embodiment of the present invention in which information required for a receiving part of a notification message, i.e. Content-ID, Content-Position, Content-Type, and Content-Transfer-Encoding are eliminated. When the terminal is supposed to request the whole notification message, it is indicated that the query format shown in Table 7A is not used in the exemplary embodiment of the present invention.

TABLE 7B
IA Notification query format

| Key | Value | Semantics |
|---|---|---|
| Type | Notification DeliveryList | The Type of expected response, |
| | Notification Messages | e.g if a Notification Delivery |
| | Notification Init Container | List or Containers are requested. |
| | Default Notification | |
| NotiType | NDN | Type of notification messages or |
| | (Network Default Notification) | delivery list is requested. |
| | PDN | Multiple values are possible |
| | (Platform Default Notification) | separated by comma. |
| | EDN | ‘All DN’ means all Default |
| | (ESG provider Default | notification types. |
| | Notification) | |
| | All DN | |
| MessageID | 16 bit positive integer | The requested Notification |
| | | message ID. |
| MessageVersion | Unsigned byte | Version number of the |
| | | notification message. |
| Subscription | String | Subscription related |
| information | | information e.g. price, currency |
| | | type, purchase type, etc. |
| StartDelivery | Date &Time (NTP timestamp, | Start time of the period of |
| | unsignedInt) | interest, this time is based on the |
| | | Notification message delivery |
| | | time, either for the messages or |
| | | for the delivery list. |
| StopDelivery | Date &Time (NTP timestamp, | Stop time of the period of |
| | unsignedInt) | interest, this time is based on the |
| | | Notification message delivery |
| | | time, either for the messages or |
| | | for the delivery list. |
| ValidFrom | Date &Time (NTP timestamp, | Start time of the period of |
| | unsignedInt) | interest, this time is based on the |
| | | Notification message expiration |
| | | time. |
| ValidTo | Date &Time (NTP timestamp, | Stop time of the period of |
| | unsignedInt) | interest, this time is based on the |
| | | Notification message expiration |
| | | time. |
| DeliveryListVersion | LASTUPDATED dateTime | LASTUPDATED version of a |
| | value (NTP timestamp, | DeliveryList. |
| | unsignedInt) | |

Table 7C is identical to Table 7A except for the addition of Service Related Notification (SRN) and Notification Service (NS) and the addition of ServiceID.

That is, Table 7C is an extension that enables the terminal to request DeliveryList or a notification message for an SRN and an NS as well as a default notification message. An NS has a ServiceID like a general service. In this case, a query format can be defined by adding ServiceID instead of MessageID.

TABLE 7C
IA Notification query format

| | | |
|---|---|---|
| NotiType | NDN(Network Default | Type of notification messages |
| | Notification) | or delivery list is requested. |
| | PDN(Platform Default | Multiple values are possible |
| | Notification) | and separated by comma. |
| | EDN(ESG provider Default | |
| | Notification) | |
| | SRN(Service Related | |
| | Notification) | |
| | NS(Notification Service) | |
| | All | |
| | All DN | |
| ServiceID | Notification Service ID | |

While not specifically shown, the query formats shown in Tables 7A, 7B and 7C may be used in combination.

### <<Define DeliveryList>>

Table 8A to Table 8E describe XML syntaxes of the proposed DeliveryList. Table 9 describes semantics of the DeliveryList shown in Table 8A to 8E.

Table 8A shows a DeliveryList for notification messages transmitted over an interactive network and Table 8B defines a DeliveryList extended to a broadcasting network. Table 8C describes an exemplary embodiment of the present invention without a SubList. The SubList is a scheme for transmitting a DeliveryList in a plurality of segments when the DeliveryList is too large. While Table 8C shows a DeliveryList for notification messages transmitted over an interactive network, it may be applied to the DeliveryList without the Sublist, extended to the broadcasting network.

Table 8D shows an exemplary embodiment of the present invention excluding a version of DeliveryList and expiration-related attributes. Since the DeliveryList is a listing of notification messages transmitted/to be transmitted at terminal-set and user-set times, information about the version of the DeliveryList may not be needed. It is observed from syntaxes in Table 8D that the attributes of ‘lastupdated’, ‘expirationDate’ and ‘expirationwindow’ are not transmitted.

Table 8E shows an exemplary embodiment of the present invention in which price and purchase information is provided as information about a terminal-requested notification message. Aside from the price information, other information is based on Table 8D. Yet, Table 8E may be applied to other DeliveryList exemplary embodiments. Although a broadcast default notification message may not require subscription and purchase, if it is transmitted over an interactive channel, i.e. a communication channel, it may require subscription and purchase.

TABLE 8A
Notification DeliveryList

```
<? Xml version=“1.0” encoding=“UTF=8”?>
<schema xmlns=“http://www.w3.org/2001/XMLSchema”
      xmlns:notif=“dvb:ipdc:2007:notification”
      elementFormDefault  :xs=  “qualified  ”
      targetNamespace  =  “dvb:ipdc:2007:notification”>
  <complexType name=“DeliveryList”>
            <sequence>
                <element  name=“SubList”  type=“notif:SubListType”
maxOccurs=“unbounded”/>
            </sequence>
            <attribute name=“lastupdated” type=“unsignedInt” use=“required”/>
            <attribute  name=“expirationDate”  type=“unsignedInt”
use=“optional”/>
            <attribute  name=“expirationWindow”  type=“unsignedInt”
use=“optional”/>
    </complexType>
    <complexType name“SubListType”>
        <sequence>
            <element  name=“IADeliveryChannel”
type=“notif:IADeliveryChannelType” minOccurs=“0”/>
            <element  name=“BCDeliveryChannel”
type=“notif:BCDeliveryChanelType” minOccurs=“0”/>
        </sequence>
        <attribute name=“subListID” type=“unsignedInt” use=“required”/>
        <attribute name=“priority” type=“unsignedInt” use=“optional”/>
        <attribute name=“lastupdatedSL” type=“unsignedInt” use=“required”/>
    </complexType>
    <complexType name“IADeliveryChannelType”>
        <sequence>
            <element name=“IAInitContainer” type=“ anyURI” minOccurs=“0”/>
            <element  name=“IAMessage”  type=“notif:IAMessageType”
maxOccurs=“unbounded”/>
        </sequence>
        <attribute name=“priority” type=“unsignedInt” use=“optional”/>
    </complexType>
    <complexType name“BCDeliveryChannelType”>
        <sequence>
            <element  name=“BCMessage”  type=“notif:BCMessageType”
maxOccurs=“unbounded”/>
        </sequence>
        <attribute name=“priority” type=“unsignedInt” use=“optional”/>
    </complexType>
    <complexType name=“IAMessageType”>
        <sequence>
            <element  name=“MessageID”  type=“unsignedShort”
maxOccurs=“unbounded”/>
        </sequence>
        <attribute name=“version” type=“unsignedShort” use=“optional”/>
        <attribute  name=“NotificationType”  type=“unsignedShort”
use=“optional”/>
        <attribute name=“size” type=“unsignedLong” use=“required”/>
    </complexType>
    <complexType name=“BCMessageType”>
        <sequence>
        <element  name=“MessageID”  type=“unsignedShort”
maxOccurs=“unbounded”/>
        <sequence>
        <attribute name=“version” type=“unsignedInt” use=“optional”/>
        <attribute  name=“NotificationType”  type=“unsignedShort”
use=“optional”/>
    </complexType>
```

TABLE 8B
Notification DeliveryList

```
<? Xml version=“1.0” encoding=“UTF=8”?>
<schema xmlns=“http://www.w3.org/2001/XMLSchema”
      xmlns:notif=“dvb:ipdc:2007:notification”
      elementFormDefault  :xs=  “qualified  ”
      targetNamespace  =  “dvb:ipdc:2007:notification”>
  <complexType name=“DeliveryList”>
            <sequence>
                <element  name=“SubList”  type=“notif:SubListType”
maxOccurs=“unbounded”/>
            </sequence>
            <attribute name=“lastupdated” type=“unsignedInt” use=“required”/>
            <attribute  name=“expirationDate”  type=“unsignedInt”
use=“optional”/>
            <attribute  name=“expirationWindow”  type=“unsignedInt”
use=“optional”/>
    </complexType>
    <complexType name“SubListType”>
        <sequence>
            <element  name=“IADeliveryChannel”
type=“notif:IADeliveryChannelType” minOccurs=“0”/>
            <element  name=“BCDeliveryChannel”
type=“notif:BCDeliveryChanelType” minOccurs=“0”/>
        </sequence>
        <attribute name=“subListID” type=“unsignedInt” use=“required”/>
        <attribute name=“priority” type=“unsignedInt” use=“optional”/>
        <attribute name=“lastupdatedSL” type=“unsignedInt” use=“required”/>
    </complexType>
    <complexType name“IADeliveryChannelType”>
        <sequence>
            <element name=“IAInitContainer” type=“ anyURI” minOccurs=“0”/>
            <element  name=“IAMessage”  type=“notif:IAMessageType”
maxOccurs=“unbounded”/>
        </sequence>
        <attribute name=“priority” type=“unsignedInt” use=“optional”/>
    </complexType>
    <complexType name“BCDeliveryChannelType”>
        <sequence>
            <element  name=“BCMessage”  type=“notif:BCMessageType”
maxOccurs=“unbounded”/>
        </sequence>
        <attribute name=“priority” type=“unsignedInt” use=“optional”/>
    </complexType>
    <complexType name=“IAMessageType”>
        <sequence>
            <element  name=“MessageID”  type=“unsignedShort”
maxOccurs=“unbounded”/>
        </sequence>
        <attribute name=“version” type=“unsignedShort” use=“optional”/>
        <attribute  name=“NotificationType”  type=“unsignedShort”
use=“optional”/>
        <attribute name=“size” type=“unsignedLong” use=“required”/>
    </complexType>
    <complexType name=“BCMessageType”>
        <sequence>
        <element  name=“MessageID”  type=“unsignedShort”
maxOccurs=“unbounded”/>
        <sequence>
        <attribute name=“version” type=“unsignedInt” use=“optional”/>
        <attribute  name=“NotificationType”  type=“unsignedShort”
use=“optional”/>
    </complexType>
```

TABLE 8C
Notification DeliveryList

```
<? Xml version=“1.0” encoding=“UTF=8”?>
<schema xmlns=“http://www.w3.org/2001/XMLSchema”
      xmlns:notif=“dvb:ipdc:2007:notification”
      elementFormDefault  :xs=  “qualified  ”
      targetNamespace =  “dvb:ipdc:2007:notification”>
  <complexType name=“DeliveryList”>
            <sequence>
                <element  name=“IADeliveryChannel”  type=“
notif  :IADeliveryChannelType” minOccurs=“0”/>
            </sequence>
            <attribute name=“lastupdated” type=“unsignedInt” use=“required”/>
            <attribute  name=“expirationDate”  type=“unsignedInt”
use=“optional”/>
            <attribute  name=“expirationWindow”  type=“unsignedInt”
use=“optional”/>
    </complexType>
    <complexType name“IADeliveryChannelType”>
        <sequence>
            <element name=“IAInitContainer” type=“anyURI” minOccurs=“0”/>
            <element  name=“IAMessage”  type=“  notif :IAMessageType”
maxOccurs=“unbounded”/>
        </sequence>
        <attribute name=“priority” type=“unsignedInt” use=“optional”/>
    </complexType>
    <complexType name=“IAMessageType”>
        <sequence>
            <element  name=“MessageID”  type=“unsignedShort”
maxOccurs=“unbounded”/>
        </sequence>
        <attribute name=“version” type=“unsignedShort” use=“optional”/>
        <attribute  name=“NotificationType”  type=“unsignedShort”
use=“optional”/>
        <attribute name=“size” type=“unsignedLong” use=“required”/>
    </complexType>
```

TABLE 8D
Notification DeliveryList

```
<? Xml version=“1.0” encoding=“UTF=8”?>
<schema xmlns=“http://www.w3.org/2001/XMLSchema”
      xmlns:notif=“dvb:ipdc:2007:notification”
      elementFormDefault  :xs=  “qualified  ”
      targetNamespace =  “dvb:ipdc:2007:notification”>
  <complexType name=“DeliveryList”>
            <sequence>
                <element  name=“IADeliveryChannel”  type=“
notif  :IADeliveryChannelType” minOccurs=“0”/>
            </sequence>
    </complexType>
    <complexType name“IADeliveryChannelType”>
        <sequence>
            <element name=“IAInitContainer” type=“anyURI” minOccurs=“0”/>
            <element  name=“IAMessage”  type=“  notif  :IAMessageType”
maxOccurs=“unbounded”/>
        </sequence>
        <attribute name=“priority” type=“unsignedInt” use=“optional”/>
    </complexType>
    <complexType name=“IAMessageType”>
        <sequence>
            <element  name=“MessageID”  type=“unsignedShort”
maxOccurs=“unbounded”/>
        </sequence>
        <attribute name=“version” type=“unsignedShort” use=“optional”/>
        <attribute  name=“NotificationType”  type=“unsignedShort”
use=“optional”/>
        <attribute name=“size” type=“unsignedLong” use=“required”/>
</complexType>
```

TABLE 8E
Notification DeliveryList

```
<? Xml version=“1.0” encoding=“UTF=8”?>
<schema xmlns=“http://www.w3.org/2001/XMLSchema”
      xmlns:notif=“dvb:ipdc:2007:notification”
      elementFormDefault  :xs=  “qualified  ”
      targetNamespace  =  “dvb:ipdc:2007:notification”>
  <complexType name=“DeliveryList”>
            <sequence>
                <element  name=“IADeliveryChannel”  type=“
notif  :IADeliveryChannelType” minOccurs=“0”/>
            </sequence>
    </complexType>
    <complexType name“IADeliveryChannelType”>
        <sequence>
            <element name=“IAInitContainer” type=“anyURI” minOccurs=“0”/>
            <element  name=“IAMessage”  type=“  notif  :IAMessageType”
maxOccurs=“unbounded”/>
        </sequence>
        <attribute name=“priority” type=“unsignedInt” use=“optional”/>
    </complexType>
    <complexType name=“IAMessageType”>
        <sequence>
            <element  name=“MessageID”  type=“unsignedShort”
maxOccurs=“unbounded”/>
<element name=“Subscriptioninfo” type=“SubsinfoType” minOccurs=“0”/>
        </sequence>
        <attribute name=“version” type=“unsignedShort” use=“optional”/>
        <attribute  name=“NotificationType”  type=“unsignedShort”
use=“optional”/>
        <attribute name=“size” type=“unsignedLong” use=“required”/>
    </complexType>
<complexType name=“SubsinfoType”>
  <sequence>
                <element name=“Price” maxOccurs=“unbounded”>
                    <complexType>
                    <simpleContent>
                        <extension base=“float”>
                            <attribute  name=“currency”
type=“esg:currencyType” use=“required”>
                    </simpleContent>
                    </complexType>
                <element  name=“PurchaseRequest”
type=“esg:PurchaseRequestType” minOccurs=“0” maxOccurs=“unbounded”/>
        </sequence>
</complexType>
<complexType name=“PurchaseRequestType”>
        <sequence>
            <element name=“DRMSystem” type=“anyURI”/>
            <element name=“PurchaseData” type=“string” minOccurs=“0”/>
        </sequence>
</complexType>
```

TABLE 9
Notification DeliveryList Semantics

| Field | Semantics | Comment |
|---|---|---|
| SubList | A DeliveryList can be split | |
| | into one or more SubLists. | |
| lastupdated | The version of the consistent | Updates are tracked |
| | ESG instance is represented by this | by comparing the |
| | DL. | fragment set in the |
| | | DL with the local |
| | | fragment DB or with |
| | | a previous DL. |
| expirationDate | NTP timestamp when this DL | |
| | expires. The terminal should | |
| | request a new DL to check | |
| | for updates within the | |
| | expirationWindow. | |
| expirationWindow | Time in seconds that gives | |
| | the time window for requests | |
| | of a new DeliveryList. | |
| lastupdatedSL | Version of the subList in an | |
| | NTP timestamp format. | |
| subListID | The ID of a specific SubList. | Starting from zero |
| | | (0). |
| | | When requesting a |
| | | SubList the |
| | | lastupdated of the |
| | | DeliveryList must be |
| | | included in the |
| | | request. |
| SubList@priority | Priority of the SubList and | |
| | the Fragments/Containers it | |
| | describes. | |
| IADeliveryChannel | The Interactive Channel | |
| | delivering the notification | |
| | message. | |
| IAInitContainer | Notification Init container | |
| | available over an interactive | |
| | channel. | |
| IAMessage | Notification message that | |
| | should be fetched over an | |
| | interactive channel. | |
| IAMessage@MessageID | Notification Message ID. | |
| IAMessage@version | Version of an Notification | |
| | message available over an | |
| | interactive channel. | |
| IAMessage@size | Size of a specific ESG | |
| | container available over an | |
| | interactive channel. | |
| IAContainer@source | A URL to direct download of | |
| | a Notification message over | |
| | the interactive channel. | |
| BCDeliveryChannel | The broadcast delivery | |
| | channel delivering the | |
| | notification message. | |
| BCDeliveryChannel@priority | Priority of a specific | If multiple channels |
| | broadcast channel. | are listed, the |
| | | priority gives a hint |
| | | to the terminal in |
| | | which sequence it |
| | | should fetch data |
| | | from the channels. |
| BCMessage | Notification message that | |
| | should be fetched over a | |
| | broadcast channel. | |
| BCMessage@containerID | Notification message ID. | |
| BCMessage@version | Version of a Notification | |
| | message available over | |
| | broadcast channel. | |
| Price | price information of the | |
| | notification. | |
| PurchaseRequest | Specifies the request to | |
| | initiate the purchase. | |
| DRM system | Specifies a URI which | |
| | identifies the DRM system. | |
| PurchaseData | Specifies a string which is | |
| | used to hold information | |
| | necessary to perform the | |
| | purchase. | |

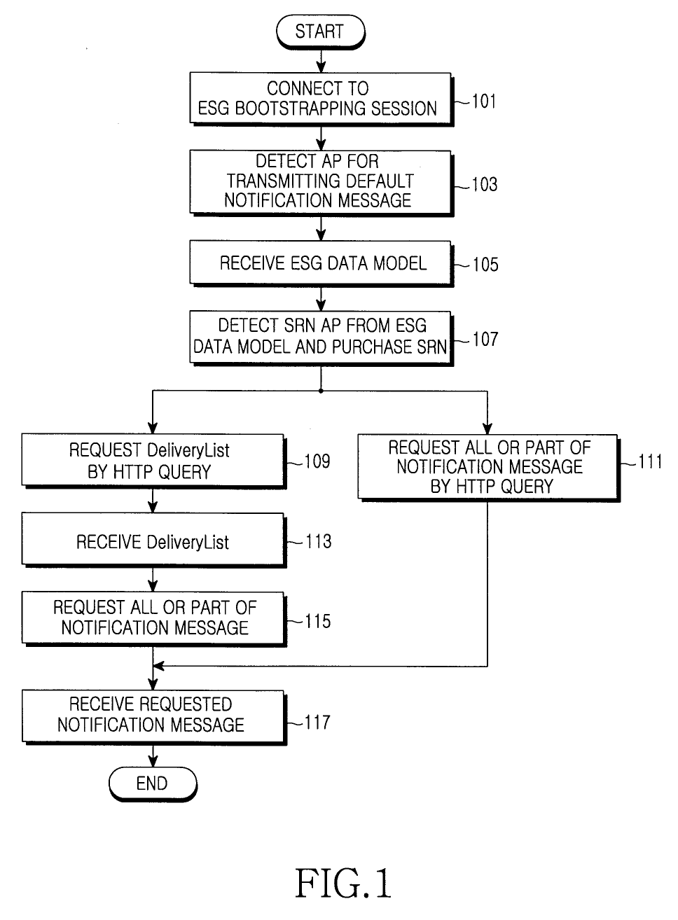

FIG. 1 is a flowchart illustrating a control operation for receiving a notification message over a communication channel at a terminal in a DVB system according to an exemplary embodiment of the present invention.

Referring to FIG. 1, the terminal accesses an ESG bootstrapping session by connecting to a broadcasting service in step 101 and checks an AP for transmitting a default notification message from the ESG bootstrapping session in step 103. The ESG bootstrapping session is composed of an ESG Provider Descriptor and an ESG Access Descriptor. The ESG Provider Descriptor includes an ID, name and logo of an ESG provider. The ESG Access Descriptor includes channel information about an Announcement session of an ESG and the number and addresses of IP sessions carrying the ESG.

In step 105, the terminal selects one ESG using the information of the ESG bootstrapping session, acquires information about the ESG by accessing an Announcement carousel of the ESG, and receives an ESG data model. Herein, the terminal receives one ESG data model among ESGs that are repeatedly transmitted in files in the Announcement carousel.

In step 107, the terminal detects an AP for transmitting an SRN in the ESG data model and purchases the SRN according to a user selection. Before receiving the data model, the terminal may have received the default notification message. In this case, the terminal receives a notification message with added information about an AP as shown in Table 1 to Table 6.

The terminal requests a DeliveryList by an HTTP Request query in step 109 or requests all or part of a notification message based on already known information about the notification message in step 111. In this case, the terminal requests transmission of the notification message using the query format shown in one of Tables 7A, 7B and 7C.

The terminal receives the DeliveryList in step 113, requests a required notification message based on information of DeliveryList in step 115, and receives the requested notification message in step 117. Notably, the terminal can request all or part of the notification message in step 115 and can receive all or part of the notification message in step 117. In this case, the notification has the configuration shown in one of Tables 8A to 8E and Table 9.

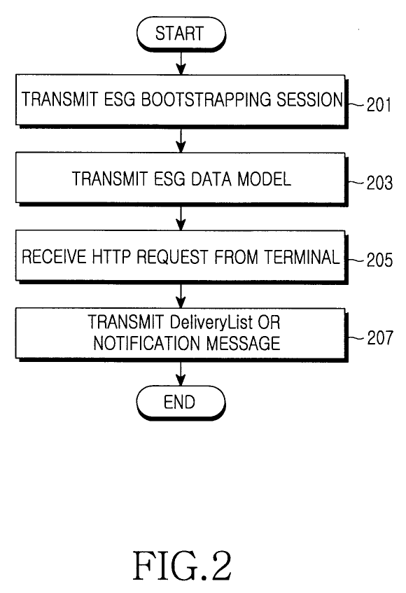

FIG. 2 is a flowchart illustrating a control operation for transmitting a notification message over a communication channel at a transmitter in a DVB system according to an exemplary embodiment of the present invention.

Referring to FIG. 2, a server opens an ESG bootstrapping session and a File Deliver over Unidirectional Transport (FLUTE) session for an ESG data model and provides an ESG to a terminal in steps 201 and 203. That is, transmission of the ESG bootstrapping session and the ESG data model in files is carried out in a unidirectional transport manner from the server to the terminal.

The server receives an HTTP Request query in step 205 and transmits a DeliveryList or all or part of a notification message to the terminal in step 207.

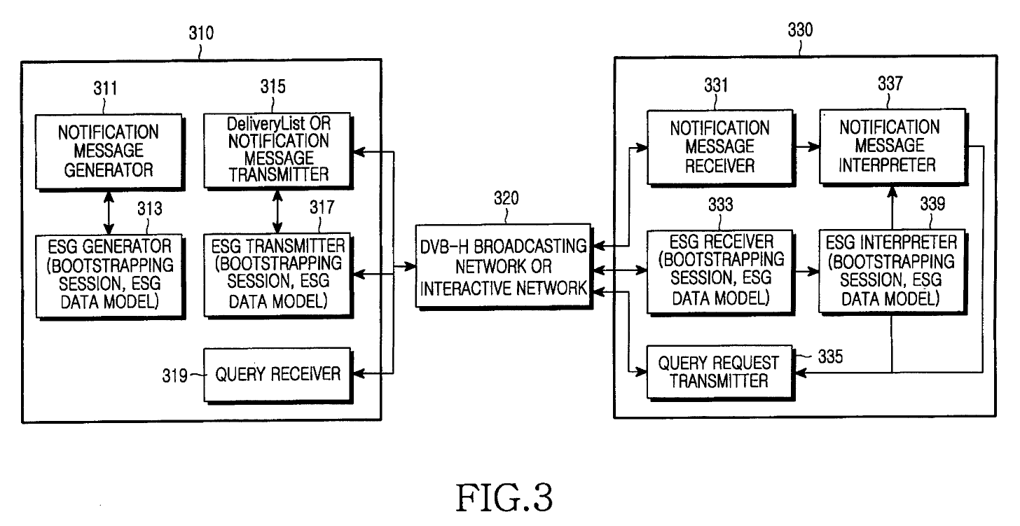

FIG. 3 is a block diagram of a system for transmitting/receiving a notification message over a communication channel in the DVB system according to an exemplary embodiment of the present invention.

Referring to FIG. 3, a server 310 includes a notification message generator 311, an ESG generator 313, a DeliveryList or notification message transmitter 315, an ESG transmitter 317, and a query receiver 319.

The notification message generator 311 generates a notification message and provides it to the notification message transmitter 315. The notification message transmitter 315 provides information about an AP for transmitting the notification message to the ESG generator 313 so that the ESG transmitter 313 can transmit the AP information to a terminal 330. The notification message transmitter 315 also transmits a DeliveryList to the terminal 330. That is, the notification message transmitter 315 analyzes a Request Query received through the query receiver 319 and transmits a requested DeliveryList or notification message to the terminal 330. A network 320 that transmits the DeliveryList or the notification message is a DVB-H broadcasting network or an interactive network.

According to an exemplary embodiment of the present invention, the terminal 330 includes a notification message receiver 331, an ESG receiver 333, a query request transmitter 335, a notification message interpreter 337, and an ESG interpreter 339.

The notification message receiver 331 receives a notification message from the server 310 and provides the notification message to the notification message interpreter 337. If the notification message has an error, the notification message receiver 331 notifies the query request transmitter 335 of the error occurrence so that the query request transmitter 335 makes a request for the notification message directly to the server 310. The terminal 330 also acquires AP information about a notification message through the ESG receiver 333 and the ESG interpreter 339 and makes a request for a DeliveryList and part or all of a notification message to the server 310, when needed.

As is apparent from the above description, exemplary embodiments of the present invention define transmission of a notification message over a communication channel and provide a mechanism and method for receiving a notification message over an interactive channel. Since the notification message is transmitted over a communication channel, a terminal has an increased chance of successfully receiving every notification message.

More particularly, exemplary embodiments of the present invention address the conventional problem that there is no guarantee for the terminal to receive a notification message successfully from a server due to the nature of a notification message and a notification service of which the transmission time is not preset. That is, as the terminal requests a DeliveryList and receives the DeliveryList, it can confirm a list of notification messages. Therefore, the terminal may successfully receive any notification message in any case.

Exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. In addition, function programs, codes, and code segments for accomplishing exemplary embodiments of the present invention can be easily construed as within the scope of the invention by programmers skilled in the art to which the present invention pertains.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for receiving a notification message at a terminal in a Digital Video Broadcasting (DVB) system, the method comprising:
detecting an Access Point (AP) from an Electronic Service Guide (ESG) bootstrapping session;
querying the AP to request a notification message list or all or part of a notification message over a communication channel; and
receiving the notification message list or all or part of the notification message from the AP.

2. The method of claim 1, wherein the detecting of the AP comprises detecting an AP of a server for broadcasting a default notification message from the ESG bootstrapping session.

3. The method of claim 2, wherein the detecting of the AP comprises detecting one of an AP of a server for transmitting a Platform Default Notification (PDN) message and an AP of a server for transmitting an ESG Default Notification (EDN) message.

4. The method of claim 1, wherein the detecting of the AP comprises:
subscribing to a Service-Related Notification (SRN) message;
purchasing the SRN message through the ESG bootstrapping session; and
detecting an AP of a server for transmitting the SRN message.

5. The method of claim 4, wherein the detecting of the AP comprises detecting one of an AP of a server for transmitting a Platform Default Notification (PDN) message and an AP of a server for transmitting an ESG Default Notification (EDN) message.

6. The method of claim 5, further comprising determining a transmission mode of the notification message.

7. The method of claim 6, wherein the transmission mode is one of a push mode in which the server notifies the terminal of the AP and a pull mode in which the terminal transmits a query about the AP to the server and receives information about the AP from the server.

8. The method of claim 5, further comprising detecting version information about the server.

9. The method of claim 1, wherein the querying of the AP comprises querying the AP using a query format including at least one of a type of a message to be transmitted, a type of a notification message, and a message IDentifier (ID).

10. The method of claim 1, wherein the querying of the AP comprises requesting a list of notification messages transmitted or to be transmitted from a server.

11. The method of claim 10, wherein the querying of the AP comprises requesting a list of notification messages transmitted from the server during a predefined time period defined by a start time and an end time.

12. The method of claim 9, wherein the querying of the AP comprises requesting transmission of part of the notification message using the message ID.

13. The method of claim 12, wherein the querying of the AP comprises requesting retransmission of part of a notification message having errors using the message ID.

14. The method of claim 1, wherein the querying of the AP comprises one of requesting initial information about a notification message and requesting an address of a server for transmitting the initial information about the notification message.

15. The method of claim 1, wherein the querying of the AP comprises requesting transmission of a default notification message that is transmitted over a broadcasting network, over an interactive network.

16. The method of claim 9, wherein the querying of the AP comprises querying the AP to request the notification message list or all or part of the notification message using a query format including a service ID.

17. A method for transmitting a notification message at a server in a Digital Video Broadcasting (DVB) system, the method comprising:
transmitting an Electronic Service Guide (ESG) bootstrapping session including information about an Access Point (AP) to a terminal;
receiving a query about requesting a notification message list or all or part of a notification message from the terminal over a communication channel; and
transmitting the notification message list or all or part of the notification message to the terminal.

18. The method of claim 17, wherein the transmitting of the notification message list or all or part of the notification message comprises transmitting the notification message list or all or part of the notification message to the terminal over a communication channel.

19. The method of claim 17, wherein the transmitting of the notification message list or all or part of the notification message comprises transmitting the notification message list or all or part of the notification message to the terminal over a broadcasting channel.

20. The method of claim 17, wherein the transmitting of the notification message list or all or part of the notification message comprises transmitting a notification message list including at least one of information indicating transmission of notification messages over a communication channel, message IDentifiers (IDs) of the notification messages, and versions of the notification messages to the terminal.

21. The method of claim 20, wherein the transmitting of the notification message list or all or part of the notification message comprises dividing the notification message list into a plurality of sub-lists and transmitting the sub-lists to the terminal.

22. The method of claim 21, wherein the transmitting of the notification message list or all or part of the notification message comprises transmitting a terminal-queried list of notification messages transmitted or to be transmitted during a predefined time period defined by a start time and an end time to the terminal.

23. The method of claim 22, wherein the transmitting of the notification message list or all or part of the notification message comprises transmitting to the terminal a notification message including price and purchase information about a Service-Related Notification (SRN) message subscribed to and purchased by the terminal.

24. A system for transmitting and receiving a notification message in a Digital Video Broadcasting (DVB) system, the system comprising:
a server for transmitting an Electronic Service Guide (ESG) bootstrapping session including information about an Access Point (AP) to a terminal, and for receiving a query about requesting a notification message list or all or part of a notification message from the terminal;
the terminal for receiving the queried notification message list or all or part of the queried notification message from the AP; and
a network for transmitting and receiving the query and the queried notification message list or all or part of the queried notification message over one of a communication channel and a broadcasting channel.

25. The system of claim 24, wherein the network includes one of a broadcasting network for transmitting and receiving the broadcasting channel and an interactive network for transmitting and receiving the communication channel.

26. The system of claim 24, wherein the server transmits a notification message including at least one of information indicating transmission of notification messages over the communication channel, message IDentifiers (IDs) of the notification messages, and versions of the notification messages to the terminal.

27. The system of claim 26, wherein the server divides the notification message list into a plurality of sub-lists and transmits the sub-lists to the terminal.

28. The system of claim 27, wherein the server transmits a list of notification messages transmitted or to be transmitted during a predefined time period defined by a start time and an end time to the terminal.

29. The system of claim 28, wherein the server transmits a terminal-queried list of notification messages transmitted or to be transmitted during a predefined time period defined by a start time and an end time to the terminal.

30. The system of claim 29, wherein the server transmits to the terminal a notification message including price and purchase information about a Service-Related Notification (SRN) message subscribed to and purchased by the terminal.

31. The system of claim 24, wherein the terminal detects an AP of a server for transmitting a default notification message over the broadcasting channel from the ESG bootstrapping session.

32. The system of claim 31, wherein the terminal detects one of an AP of a server for transmitting a Platform Default Notification (PDN) message and an AP of a server for transmitting an ESG Provider Default Notification (EDN) message.

33. The system of claim 24, wherein the terminal subscribes to a Service-Related Notification (SRN) message and purchases the SRN message through the ESG bootstrapping session, and detects an AP of a server for transmitting the SRN message.

34. The system of claim 33, wherein the terminal detects one of an AP of a server for transmitting a Platform Default Notification (PDN) message and an AP of a server for transmitting an ESG Provider Default Notification (EDN) message.

35. The system of claim 34, wherein the terminal determines a transmission mode of the notification message.

36. The system of claim 35, wherein the transmission mode is one of a push mode in which the server notifies the terminal of the AP and a pull mode in which the terminal transmits a query about the AP to the server and receives information about the AP from the server.

37. The system of claim 34, wherein the terminal determines version information about the server.

38. The system claim 24, wherein the terminal queries the AP by a query format including at least one of a type of a message to be transmitted, a type of a notification message, and a message IDentifier (ID).

39. The system of claim 38, wherein the terminal requests a list of notification messages transmitted or to be transmitted from the server.

40. The system of claim 39, wherein the terminal requests a list of notification messages transmitted from the server during a predefined time period defined by a start time and an end time.

41. The system of claim 38, wherein the terminal queries about transmission of part of the notification message using the message ID.

42. The system of claim 41, wherein the terminal requests retransmission of part of a notification message having transmission errors using the message ID.

43. The system of claim 42, wherein the terminal queries about initial information about a notification message and an address of a server for transmitting the initial information about the notification message.

44. The system of claim 24, wherein the terminal queries about transmission of a default notification message that is transmitted over a broadcasting network, over an interactive network.

45. The system of claim 44, wherein the terminal queries about requesting the notification message list or all or part of the notification message by a query format including a service ID.

46. The system of claim 24, wherein the terminal comprises:
an ESG receiver for receiving the ESG bootstrapping session;
an ESG interpreter for acquiring information about the AP from the received ESG bootstrapping session;
a query request transmitter for requesting transmission of the notification message list, or all or part of the notification message;
a notification message receiver for receiving the requested notification message list, or the requested all or part of the notification message; and
a notification interpreter for determining whether the notification message list, or all or part of the notification message has errors by interpreting the notification message list, or all or part of the notification message and for requesting retransmission of the notification message list, or all or part of the notification message.

47. The system of claim 24, wherein the server comprises:
an ESG generator for generating the ESG bootstrapping session including the information about the AP;
an ESG transmitter for transmitting the ESG bootstrapping session;
a query receiver for receiving the query about requesting the notification message list, or all or part of the notification message from the terminal;
a notification message generator for generating the notification message list, or all or part of the notification message according to the received query; and
a notification message transmitter for transmitting the notification message list, or all or part of the notification message to the terminal.
